(19) United States
(12) Patent Application Publication
(10) Pub. No.: US 2026/0260961 A1
(43) Pub. Date: Sep. 3, 2026

(54) BATTERY PACK

(71) Applicant: TECHTRONIC CORDLESS GP, Anderson, SC (US)

(72) Inventors: Hei Man LEE, Hong Kong (CN); Jin Hui ZHOU, Dongguan City (CN); Dian Wu XU, Dongguan City (CN); Kui ZENG, Dongguan City (CN); Pei LIAO, Dongguan City (CN)

(21) Appl. No.: 19/474,148

(22) PCT Filed: Apr. 13, 2023
(86) PCT No.: PCT/CN2023/088126

§ 371 Date: Oct. 9, 2025

(51) Int. Cl. H01M 10/6551; H01M 10/613; H01M 10/6235; H01M 10/643; H01M 50/213; H01M 50/247; H01M 50/284; H01M 50/519

(52) U.S. Cl. CPC H01M 10/6551; H01M 10/613; H01M 10/6235; H01M 10/643; H01M 50/213; H01M 50/247; H01M 50/284; H01M 50/519; H01M 2220/30

(57) ABSTRACT

A battery pack for an electrical device includes a housing having at least one terminal configured to electrically connect the battery pack to the electrical device, a plurality of battery cells disposed within the housing and configured to supply power to the electrical device, a support structure configured to receive and support the plurality of battery cells within the housing, and a circuit board disposed within the housing atop the support structure and including a plurality of electrical components. The circuit board is configured to selectively power the plurality of battery cells. The circuit board further includes an overlayment covering at least some of the plurality of electrical components to protect the circuit board from dirt, debris, and water. As such, the overlayment is configured to waterproof the circuit board in some embodiments.

### FIELD OF THE DISCLOSURE

The present disclosure relates to battery packs, and more particularly, to circuit boards used in battery packs.

### SUMMARY

Power tools may be powered by portable battery packs. These battery packs range in battery chemistry and nominal voltage, and can be used to power numerous tools and electrical devices. Due to the electrical nature of the subcomponents in battery packs, it is advantageous to protect the subcomponents from moisture, dust, and/or debris to maintain optimal battery performance.

Thus, the present disclosure provides, in one aspect, a battery pack for an electrical device includes a housing having at least one terminal configured to electrically connect the battery pack to the electrical device, a plurality of battery cells disposed within the housing and configured to supply power to the electrical device, a support structure configured to receive and support the plurality of battery cells within the housing, and a circuit board disposed within the housing atop the support structure and including a plurality of electrical components. The circuit board is configured to selectively power the plurality of battery cells. The circuit board further includes an overlayment covering at least some of the plurality of electrical components.

The present disclosure includes that the overlayment is composed of a polymer material.

The present disclosure includes that the polymer material is a polyamide and a polyolefin material.

The present disclosure includes that the overlayment is formed by low pressure molding.

The present disclosure includes that the plurality of electrical components is a first plurality of electrical components disposed within a first area of the circuit board, and wherein the circuit board further includes a second plurality of electrical components disposed within a second area of the circuit board that is different from the first area.

The present disclosure further includes a heat sink that is in direct contact with the second plurality of electrical components of the second area that is devoid of the overlayment, and wherein the overlayment is disposed on the first area of the circuit board to cover the first plurality of electrical components.

The present disclosure includes that the heat sink captures and dissipates heat away from the second plurality of electrical components.

The present disclosure includes that the overlayment is disposed on the first area of the circuit board and a heat sink is disposed on the second area of the circuit board.

The present disclosure includes that the overlayment is disposed on the first area and the second area, and further comprising a heatsink extending through the overlayment to contact the second plurality of electrical components.

The present disclosure includes that the overlayment covers the first plurality of electrical components.

The present disclosure includes that the overlayment is coupled to the second area after the heat sink is coupled to the second plurality of electrical components, such that a lower portion of the heat sink is surrounded by the overlayment and an upper portion of the heat sink is not covered by the overlayment.

The present disclosure provides, in another aspect, a battery pack for an electrical device includes a housing having at least one terminal configured to electrically connect the battery pack to the electrical device, a plurality of battery cells disposed within the housing and configured to supply power to the electrical device, a support structure configured to receive and support the plurality of battery cells within the housing, a circuit board disposed within the housing atop the support structure and including a plurality of electrical components, the circuit board is configured to selectively power the plurality of battery cells, and a variable thickness overlayment covering at least some of the plurality of electrical components and is composed of a polymer material.

The present disclosure includes that the polymer material is a polyamide and a polyolefin material.

The present disclosure includes that the plurality of battery cells include a lithium-based chemistry.

The present disclosure includes that the overlayment includes a first thickness portion and a second thickness portion, and wherein the second thickness portion is greater than the first thickness portion.

The present disclosure includes that the plurality of electrical components is a first plurality of electrical components disposed within a first area of the circuit board, and wherein the circuit board further includes a second plurality of electrical components disposed within a second area of the circuit board that is different from the first area.

The present disclosure includes further comprising a heat sink that is in direct contact with the second plurality of electrical components of the second area that is devoid of the overlayment, and wherein the overlayment is disposed on the first area of the circuit board to cover the first plurality of electrical components.

The present disclosure includes that the heat sink captures and dissipates heat away from the second plurality of electrical components.

Other aspects of the disclosure will become apparent by consideration of the detailed description and accompanying drawings.

### BRIEF DESCRIPTION OF THE DRAWINGS

FIG. 1 is a perspective view of a battery pack according to an embodiment of the invention.

FIG. 2 is a rear perspective view of the battery pack of FIG. 1 according to some embodiments.

FIG. 3 is an exploded view of the battery pack of FIG. 1 according to some embodiments.

FIG. 4 is a perspective view of the battery pack of FIG. 1 with a first housing portion of a housing removed, according to some embodiments.

FIG. 5 is a perspective view of a circuit board including an overlayment and a heat sink for the battery pack of FIG. 1, according to some embodiments.

FIG. 6 is a perspective view of the circuit board of FIG. 5 with the heat sink removed, according to some embodiments.

FIG. 7 is a top view of the circuit board of FIG. 5 with the heat sink removed, according to some embodiments.

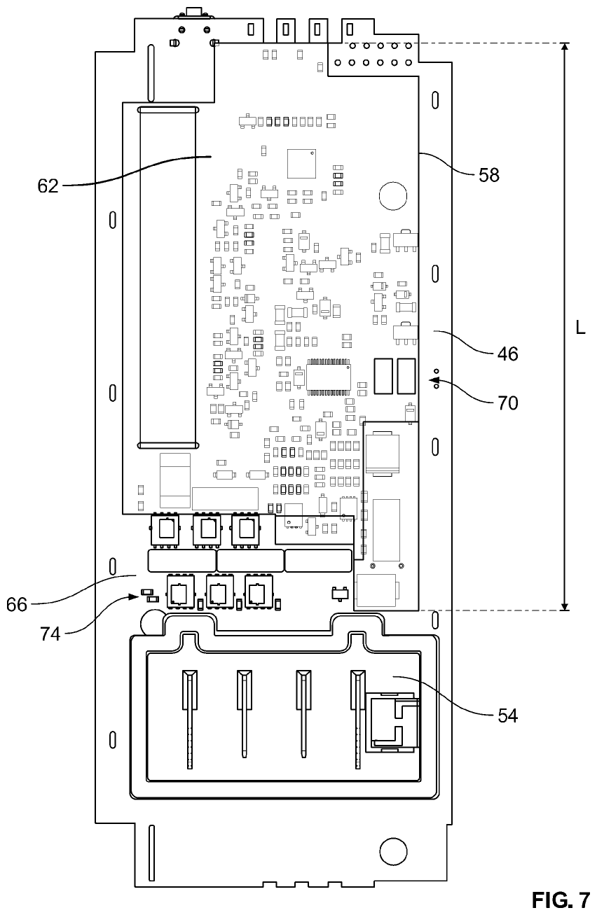

FIG. 8 is a side view of the circuit board of FIG. 5 with the heat sink removed, according to some embodiments.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

Features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

### DETAILED DESCRIPTION

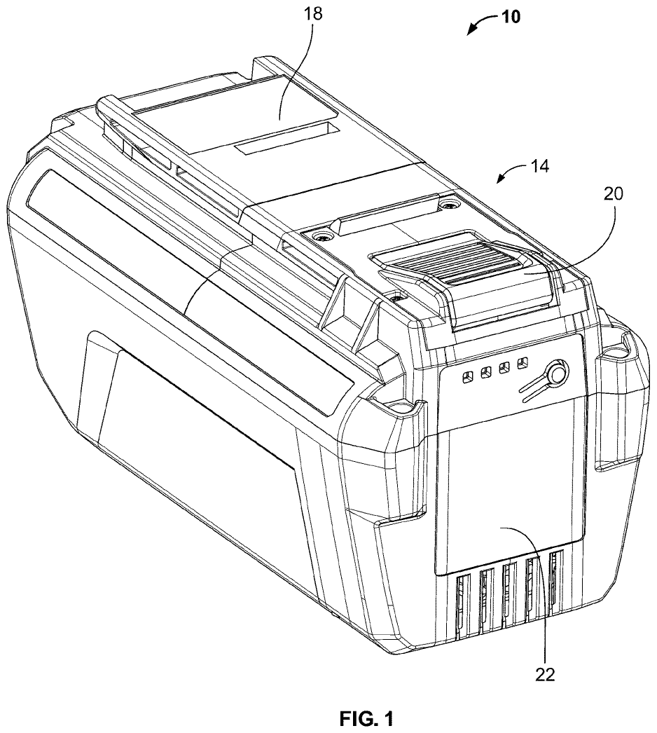

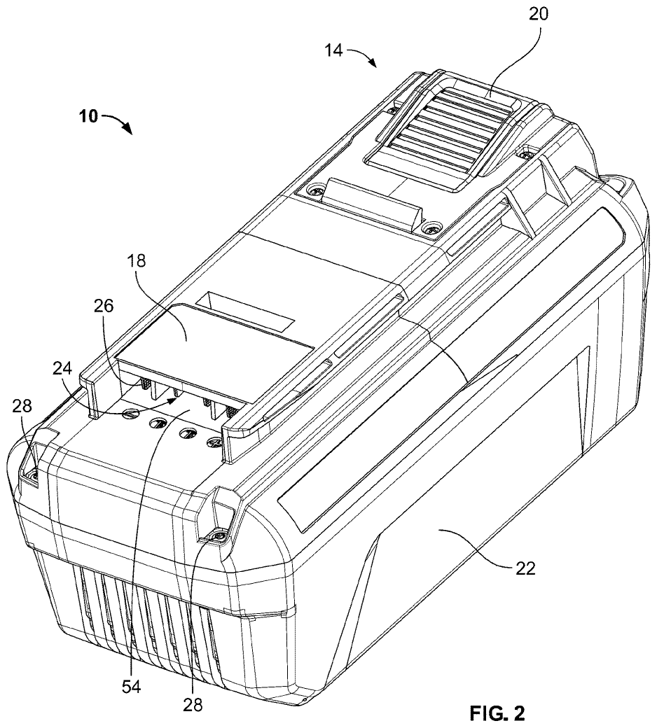

FIGS. 1 and 2 illustrate a battery pack 10 according to some embodiments. The battery pack 10 is connectable and operable to power electrical equipment, such as but not limited to, hand-held power tools (e.g., drills, fasteners, saws, pipe cutters, sanders, nailers, staplers, vacuum cleaners, etc.), motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, riding lawn mower etc.), other motorized devices (e.g., vehicles, utility carts, a material handling cart, etc.), and non-motorized electrical devices (e.g., a power source, a light, an AC/DC adapter, a generator, personal electronic device, etc.), any one of which may now be referred to herein as “electrical device.” Still, in other embodiments, the battery pack 10 is connectable and operable to power other electrical devices. The battery pack 10 is removable from the electrical device and is rechargeable by a battery charger (not shown).

The battery pack 10 includes a battery chemistry such as, lead-acid, Nickel-cadmium (“NiCd”), Nickel-Metal Hydride (“NiMH”), Lithium (“Li”), Lithium-ion (“Li-ion”), other Lithium-based chemistry, or other rechargeable or non-rechargeable battery chemistry. In some embodiments, the battery pack 10 can have a battery chemistry of Li, Li-ion, or another Li-based chemistry and can supply an average discharge current that is equal to or greater than approximately 20 A. In one example, the battery pack 10 can have a chemistry of Lithium Cobalt (“Li—Co”), Lithium Manganese (“Li—Mn”) Spinel, Li—Mn Nickel, or other lithium metal chemistry. Furthermore, the battery pack 10 may include one or more cylindrical battery cells, one or more pouch battery cells, or one or more prismatic battery cells.

The battery pack 10 includes a nominal voltage. In some embodiments, the battery pack 10 can have a nominal voltage of approximately 9.6 V. In other embodiments, the battery pack 10 can have a nominal voltage up to approximately 50 V. In some embodiments, the battery pack 10 can have a nominal voltage of approximately 21 V. In other embodiments, the battery pack 10 can have a nominal voltage of approximately 28 V. Still, in other embodiments, the battery pack 10 can have a nominal voltage, such as, 12 V, 14.4 V, 18 V, 24 V, 40 V, or 80 V to power the electrical device and be charged by the battery charger (not shown).

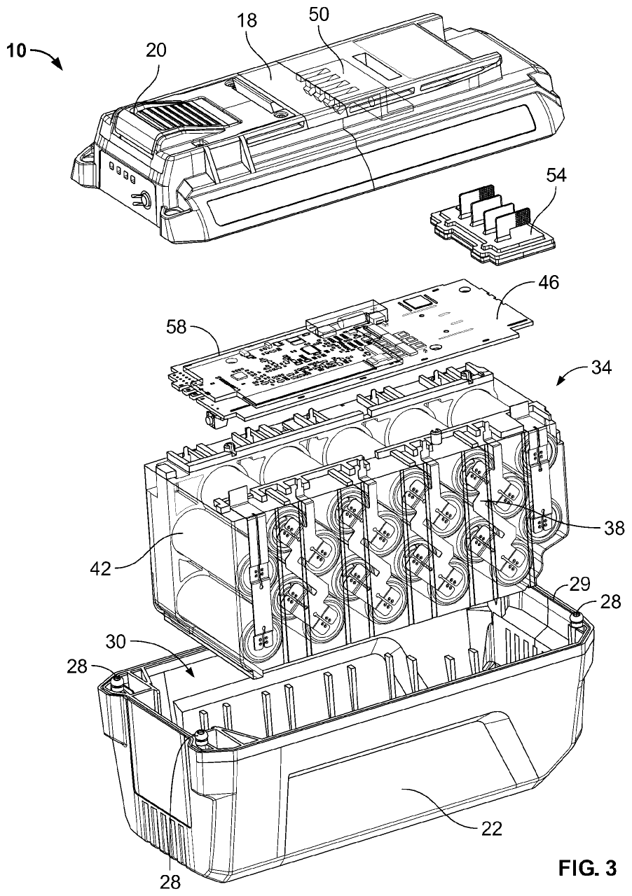

With continued reference to FIGS. 1 and 2, the battery pack 10 includes a housing 14 having a first housing portion 18 and a second housing portion 22. The battery pack 10 further includes an electrical interface 24 having one or more terminals 26 that are configured to interface and electrically connect to the electrical device. The first housing portion 18 and the second housing portion 22 may be coupled together via a plurality of fasteners 28. However in other embodiments, the first housing portion 18 may be coupled to the second housing portion 22 via an adhesive and/or compression. An O-ring (not shown) may be disposed at the interface between the first housing portion 18 and the second housing portion 22 to inhibit dirt and other debris from entering the housing 14. Specifically, the O-ring is partially received within a groove 29 (FIG. 3) that extends around the periphery of the second housing portion 22 and is further received within a corresponding groove (not shown) that extends around the periphery of the first housing portion 18 when the first and second housing portions 18, 22 are coupled together. Although fasteners 28 are used to couple the first and second housing portion 18, 22 together in the illustrated embodiment, in other embodiments, the first housing portion 18 and the second housing portion 22 can be coupled together via adhesives, tapes, fasteners, tabs, or any combination thereof. The battery pack 10 further includes a locking mechanism 20 that is configured to selectively couple the battery pack 10 to the electrical device.

With reference to FIG. 3, the housing 14 defines an internal cavity 30. The housing 14, and more specifically, the internal cavity 30 receives and supports a battery cell assembly 34. The battery cell assembly 34 includes a plurality of battery cells 38 and a support structure (such as a battery cell holder) 42 that receives and supports the plurality of battery cells 38. The plurality of battery cells 38 include a chemistry and a nominal voltage as described above. In the illustrated embodiment, the housing 14 is shaped and sized to receive twenty battery cells 38, while in other embodiments, the housing 14 may receive a different predetermined number of battery cells 38 (e.g., ten, thirty, forty, one hundred, etc.). In some embodiments, the battery cell assembly 34 can include two or more battery cells 38. The battery cells 38 can be connected in series, parallel, or combination series-parallel to provide the desired electrical characteristics (e.g., nominal voltage, current output, current capacity, power capacity, etc.) of the battery pack 10.

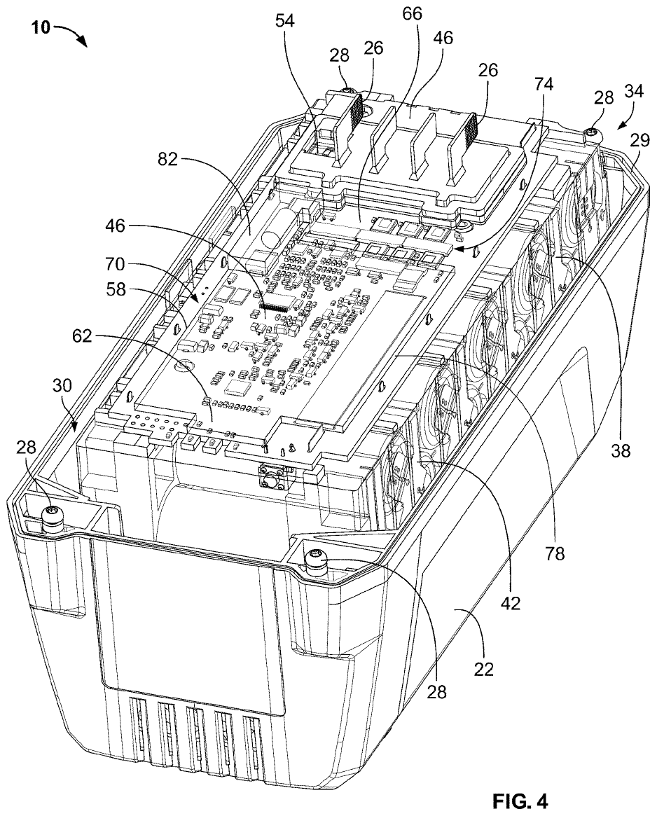

With reference to FIGS. 3 and 4, the housing 14 substantially encloses a supporting circuit or circuit board 46 electrically connected to the one or more terminals 26. The circuit board 46 is disposed above and supported by the battery cell assembly 34, such that the circuit board 46 is located within the first housing portion 18 of the housing 14. In particular, the circuit board 46 is supported on top of the support structure 42 of the battery cell assembly 34 and adjacent the first housing portion 18. The circuit board 46 includes a microcontroller or microprocessor and is configured to provide operational control of the battery pack 10 and monitor various characteristics (e.g., voltage, temperature, etc.) of each individual battery cell 38. For example, the circuit board 46 controls the electrical components within the battery pack 10 in order to control the charging and discharging of the battery cells 38. Put simply, the circuit board 46 may supply power to the electrical device via the battery cells 38. That said, the circuit board 46 may communicate with the electrical device, the battery charger (not shown), and may provide information to the devices regarding one or more battery characteristics or conditions of the battery pack 10, such as, the nominal voltage, the temperature, the chemistry, and/or other similar characteristics.

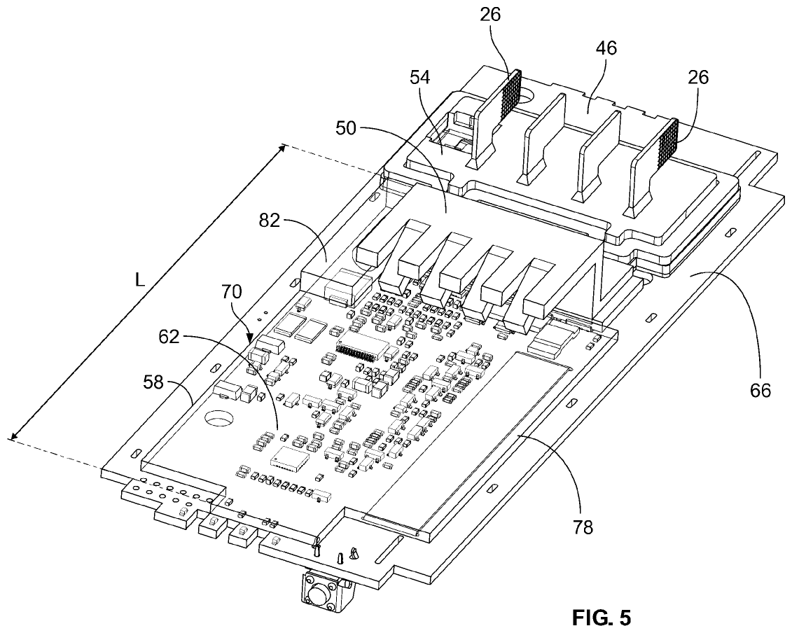

With reference to FIGS. 4 and 5, the battery pack 10 may include a heat sink 50 and a terminal contact plate 54 that is adjacent the heat sink 50. The heat sink 50 is disposed on and extends above the circuit board 46. The heat sink 50 is directly above some of the electrical components of the circuit board 46, allowing the heat sink 50 to capture heat that is expelled from the circuit board 46 and dissipate the heat away from the circuit board 46 to avoid inadvertent damage from overheating. The terminal contact plate 54 is also disposed on the circuit board 46 adjacent the heat sink 50. Although the first housing portion 18 extends around the electrical interface 24, the terminals 26 and the terminal contact plate 54 are accessible from outside the housing 14 to allow the electrical device to directly engage the electrical interface 24.

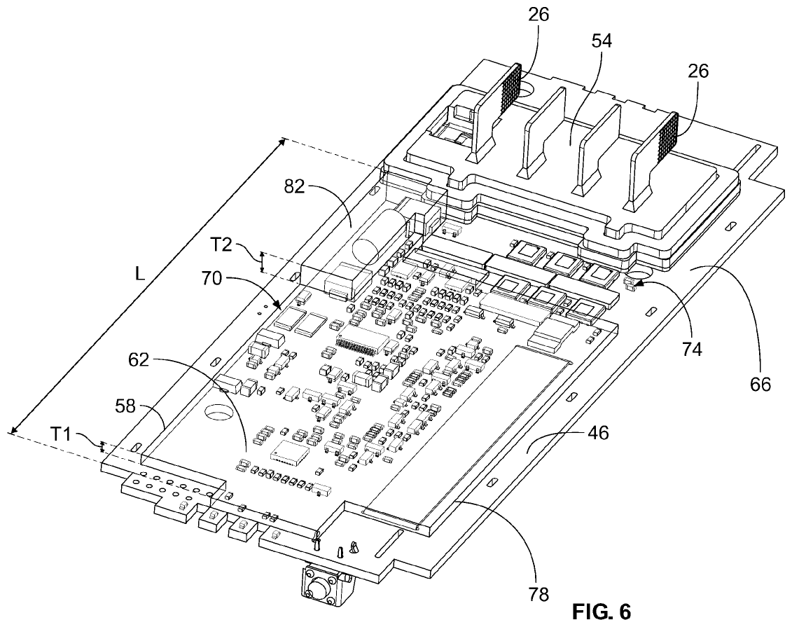

FIGS. 5 and 6 illustrate the circuit board 46 including an overlayment 58 (i.e., molding, casing, enclosure, etc.) that is configured to environmentally protect the circuit board 46 from dirt, debris, and/or water. As such, the overlayment 58 is configured to waterproof the circuit board 46 in some embodiments. The overlayment 58 is disposed on the circuit board 46 and, in some embodiments, covers or shields only a portion of the circuit board 46. That is, the overlayment 58 does not cover the entire circuit board 46, thereby allowing some components to be in direct contact with the circuit board 46 without the overlayment 58 being intermediately disposed therebetween. Specifically, the overlayment 58 is disposed on a first area 62 of the circuit board 46, which includes a first plurality of electrical components 70 such as, capacitors, resistors, inductors, sensors, and/or processors that do not require contact with the heat sink 50 and are susceptible to being damaged from contact with water or debris. As such, the overlayment 58 is configured to environmentally protect the first plurality of electrical components 70.

Furthermore, the overlayment 58 may not be disposed on a second area 66 of the circuit board 46 that is different from the first area 62 where the heat sink 50 and the terminal contact plate 54 couple to the circuit board 46. In other words, the second area 66 of the circuit board 46 may be devoid of the overlayment 58, such that the heat sink 50 may capture and dissipate heat away from a second plurality of electrical components 74 that are disposed on the second area 66. The second plurality of electrical components 74 include, for example, capacitors, resistors, inductors, sensors, and/or processors. Put simply, the heat sink 50 is in thermal contact with the second plurality of electrical components 74 to capture and dissipate heat away from the second plurality of electrical components 74 without the overlayment 58 thermally insulating the electrical components 74 from the heat sink 50.

In other embodiments, the overlayment 58 is disposed on the first area 62 and the second area 66. In such an embodiment, the heat sink 50 contacts the second plurality of electrical components 74 and then the overlayment 58 is disposed on the second area 66. In other words, the overlayment 58 is disposed on the second area 66 after the heat sink 50 is coupled to the second plurality of electrical components 74.

The overlayment 58 may be composed of a polymer material. The overlayment 58 may be formed from a different material than the circuit board 46, the heat sink 50, and/or the terminal contact plate 54. In some embodiments, the overlayment 58 may be formed from a polyamide and a polyolefin material. In some embodiments, the overlayment 58 may be formed from a thermoplastic or hot-melt material. Still, in some embodiments, the overlayment 58 may be formed from a heat conductive glue or adhesive. Yet, in other embodiments, the overlayment 58 may include a water resistant or waterproof material. For example, the overlayment 58 can be formed from a hydrophobic material including, acrylics, epoxies, polyethylene, polystyrene, polyvinylchloride, polytetrafluorethylene, polydimethylsiloxane, polyesters, or polyurethanes.

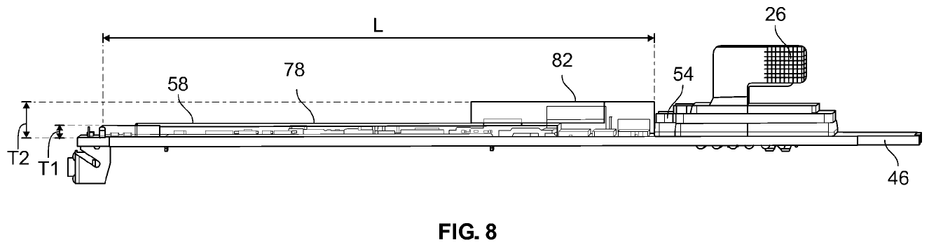

Referring to FIGS. 6 and 8, the overlayment 58 defines a thickness that is measured in a direction perpendicular from a length axis L of the circuit board 46. In some embodiments, the thickness of the overlayment 58 varies in thickness, such that the overlayment 58 defines a first thickness portion 78 and a second thickness portion 82 that is greater than the first thickness portion 78. The first thickness portion 78 defines a first thickness T1 and the second thickness portion 82 defines a second thickness T2 that is greater than the first thickness T1. The first thickness portion 78 allows coverage over the plurality of electrical components 70 having a first, smaller height, whereas the second thickness portion 82 allows coverage over the plurality of electrical components 70 having a second, larger height.

Described in further detail below is a method of manufacturing the circuit board 46 including the overlayment 58. The method includes providing the circuit board 46 with the overlayment 58, which may be formed from a low pressure molding process. The low pressure molding process can include the steps of melting a molding material into a liquid state, placing the circuit board 46 or a portion of the circuit board 46 into a mold cavity, injecting the molding material into the mold cavity where the molding material is on injected onto the first area 62 of the circuit board 46, allowing the molding material to cool to room temperature, and removing the circuit board 46 from the mold cavity.

The advantages of low pressure molding include the type of material, low viscosity, and adhesion properties. Low pressure molding can utilize thermoplastics (i.e., a material that can be re-shaped due to the material being less viscous when heated, and then hardens to keep the desired shape upon cooling down). Low pressure molding utilizes a low viscosity (e.g., 3000 centipoise) requiring a low injection pressure to inject into the mold cavity. Low pressure molding is beneficial for over molding fragile electronic components. The low pressure molding process utilizes materials (i.e., thermoplastics or polyamides) that include beneficial adhesive properties (i.e., adhesion is purely mechanical) that properly encapsulate and environmentally protect the desired electrical components on the circuit board 46.

Various features of the disclosure are set forth in the following claims.

What is claimed is:

1. A battery pack for an electrical device, the battery pack comprising:
a housing including at least one terminal configured to electrically connect the battery pack to the electrical device;
a plurality of battery cells disposed within the housing and configured to supply power to the electrical device;
a support structure configured to receive and support the plurality of battery cells within the housing;
a circuit board disposed within the housing atop the support structure and including a plurality of electrical components, the circuit board is configured to selectively power the plurality of battery cells; and
an overlayment covering at least some of the plurality of electrical components.

2. The battery pack of claim 1, wherein the overlayment is composed of a polymer material.

3. The battery pack of claim 2, wherein the polymer material is a polyamide and a polyolefin material.

4. The battery pack of claim 1, wherein the overlayment is formed by low pressure molding.

5. The battery pack of claim 1, wherein the plurality of electrical components is a first plurality of electrical components disposed within a first area of the circuit board, and wherein the circuit board further includes a second plurality of electrical components disposed within a second area of the circuit board that is different from the first area.

6. The battery pack of claim 5, further comprising a heat sink that is in direct contact with the second plurality of electrical components of the second area that is devoid of the overlayment, and wherein the overlayment is disposed on the first area of the circuit board to cover the first plurality of electrical components.

7. The battery pack of claim 6, wherein the heat sink captures and dissipates heat away from the second plurality of electrical components.

8. The battery pack of claim 5, wherein the overlayment is disposed on the first area of the circuit board and a heat sink is disposed on the second area of the circuit board.

9. The battery pack of claim 8, wherein the overlayment is composed of a polymer material.

10. The battery pack of claim 9, wherein the polymer material is a polyamide and a polyolefin material.

11. The battery pack of claim 5, wherein the overlayment is disposed on the first area and the second area, and further comprising a heatsink extending through the overlayment to contact the second plurality of electrical components.

12. The battery pack of claim 11, wherein the overlayment covers the first plurality of electrical components.

13. The battery pack of claim 12, wherein the overlayment is coupled to the second area after the heat sink is coupled to the second plurality of electrical components, such that a lower portion of the heat sink is surrounded by the overlayment and an upper portion of the heat sink is not covered by the overlayment.

14. A battery pack for an electrical device, the battery pack comprising:
a housing including at least one terminal configured to electrically connect the battery pack to the electrical device;
a plurality of battery cells disposed within the housing and configured to supply power to the electrical device;
a support structure configured to receive and support the plurality of battery cells within the housing;
a circuit board disposed within the housing atop the support structure and including a plurality of electrical components, the circuit board is configured to selectively power the plurality of battery cells; and
an overlayment having a variable thickness and covering at least some of the plurality of electrical components, the overlayment is composed of a polymer material.

15. The battery pack of claim 14, wherein the polymer material is a polyamide and a polyolefin material.

16. The battery pack of claim 14, wherein the plurality of battery cells include a lithium-based chemistry.

17. The battery pack of claim 14, wherein the overlayment includes a first thickness portion and a second thickness portion, and wherein the second thickness portion is greater than the first thickness portion.

18. The battery pack of claim 14, wherein the plurality of electrical components is a first plurality of electrical components disposed within a first area of the circuit board, and wherein the circuit board further includes a second plurality of electrical components disposed within a second area of the circuit board that is different from the first area.

19. The battery pack of claim 18, further comprising a heat sink that is in direct contact with the second plurality of electrical components of the second area that is devoid of the overlayment, and wherein the overlayment is disposed on the first area of the circuit board to cover the first plurality of electrical components.

20. The battery pack of claim 19, wherein the heat sink captures and dissipates heat away from the second plurality of electrical components.
